(19) United States
(12) Patent Application Publication
(10) Pub. No.: US 2007/0189960 A1
(43) Pub. Date: Aug. 16, 2007

(54) Method for generation of hydrogen gas from borohydride

(76) Inventor: John Hiroshi Yamamoto, Andover, MA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/704,644

(22) Filed: Feb. 9, 2007

Related U.S. Application Data
(60) Provisional application No. 60/774,258, filed on Feb. 16, 2006.

(51) Int. Cl. C01B 3/02

(52) U.S. Cl. 423/648.1

(57) ABSTRACT

A method for generation of hydrogen by combining a solid composition containing a borohydride compound and a base with an aqueous solution of an acid.

This application claims the benefit of priority under 35 U.S.C. §119(e) of U.S. Provisional Patent Application No. 60/774,258 filed on Feb. 16, 2006.

This invention relates to a method for generation of hydrogen gas from a borohydride-containing formulation. This method is useful for hydrogen generation in fuel cells.

Borohydride-containing compositions are known as hydrogen sources for hydrogen fuel cells, usually in the form of aqueous solutions. Solid borohydride-containing compositions also have been used. For example, U.S. Pub. No. 2005/0238573 discloses the use of solid sodium borohydride, which is combined with aqueous acid to produce hydrogen. However, the problem of quickly stopping the generation of hydrogen is not adequately addressed by this reference.

The problem addressed by this invention is to find a method for generation of hydrogen gas from a borohydride-containing formulation that allows hydrogen generation to be stopped relatively rapidly.

### STATEMENT OF INVENTION

The present invention provides a method for generation of hydrogen comprising: (a) providing a solid composition comprising from 3% to 50% of at least one base; and 50% to 97% of at least one borohydride compound; and (b) adding to the solid composition an aqueous solution of at least one acid; said aqueous solution comprising from 0.01 to 2 equivalents of acid; wherein the solid composition and the aqueous solution are substantially free of transition metals from groups 8, 9 and 10.

### DETAILED DESCRIPTION

Percentages are weight percentages and temperatures are in ° C., unless specified otherwise. An “organic acid” is an acidic compound, i.e., one with a pKₐ<6, which contains carbon and hydrogen. An “inorganic acid” is an acid which does not contain carbon. A “base” is a compound with a pKₐ>8 which is solid at 40° C.

In one embodiment, the amount of borohydride compound(s) in the solid composition is at least 75%, alternatively at least 85%, alternatively at least 86%, alternatively at least 87%; the amount of base(s) is no more than 25%, alternatively no more than 15%, alternatively no more than 14%, alternatively no more than 13%. In one embodiment of the invention, the amount of base in the solid composition is at least 5%; the amount of borohydride compound is no more than 95%. Preferably, the borohydride compound is a metal salt which has a metal cation from groups 1, 2, 4, 5, 7, 11, 12 or 13 of the periodic table, or a mixture thereof. In one embodiment, the borohydride compound is an alkali metal borohydride or mixture thereof, alternatively it comprises sodium borohydride (SBH) or potassium borohydride or a mixture thereof, alternatively sodium borohydride. Preferably, the base is an alkali metal hydroxide or mixture thereof, alkali metal alkoxide or alkaline earth alkoxide or combination thereof; alternatively it is an alkali metal hydroxide or sodium or potassium methoxide, or mixture thereof; alternatively sodium, lithium or potassium hydroxide or sodium or potassium methoxide, or a mixture thereof; alternatively sodium hydroxide or potassium hydroxide; alternatively sodium hydroxide. More than one alkali metal borohydride and more than one base may be present.

Preferably, the acid is an organic acid and/or an inorganic acid. In one embodiment of the invention, the acid is an organic acid. Preferably, the organic acid is a carboxylic acid. In one embodiment of the invention, the organic acid is a C₂-C₅ dicarboxylic acid, a C₂-C₅ hydroxy carboxylic acid, a C₂-C₅ hydroxy dicarboxylic acid or a combination thereof. More than one organic acid may be present in the aqueous solution. Especially preferred organic acids include malic acid, citric acid, tartaric acid, malonic acid and oxalic acid. In another embodiment of the invention, the acid is an inorganic acid. Preferably, the inorganic acid is a concentrated mineral acid, e.g., hydrochloric acid, sulfuric acid and/or phosphoric acid. Preferably the inorganic acid is not nitric acid or another strongly oxidizing acid. More than one inorganic acid may be present in the aqueous solution. Both organic and inorganic acids may be present in the aqueous solution.

In one embodiment of the invention, the aqueous solution contains from 0.1 to 1 equivalents of acid. For this purpose, equivalents are measured as equivalents of hydrogen ion for reaction with borohydride. The aqueous solution also may contain small amounts of additives, e.g., anti-foaming agents, surfactants, etc. Preferably, the aqueous solution contains no more than 10% of anything other than water and acid, alternatively no more than 5%, alternatively no more than 1%.

The solid composition of this invention may be in any convenient form. Examples of suitable solid forms include powder, granules, and compressed solid material. Preferably, powders have an average particle size less than 80 mesh (177 μm). Preferably, granules have an average particle size from 10 mesh (2000 μm) to 40 mesh (425 μm). Compressed solid material may have a size and shape determined by the equipment comprising the hydrogen generation system. In one embodiment of the invention, compressed solid material is in the form of a typical caplet used in other fields. The compaction pressure used to form compressed solid material is not critical.

The solid composition is substantially free of substances that catalyze hydrolysis of borohydride, e.g., salts of transition metals in groups 8, 9 and 10; such as Co, Ru, Ni, Fe, Rh, Pd, Os, Ir, Pt, or mixtures thereof, and borides of Co and/or Ni.

Preferably, the water content of the solid composition is no more than 0.5%, alternatively no more than 0.2%, alternatively no more than 0.1%. Preferably, the solid composition contains less than 20% of anything other than the borohydride compound and the base, alternatively less than 15%, alternatively less than 10%, alternatively less than 5%. Other possible constituents of the solid composition include, e.g., catalysts, acids, anti-foam agents and surfactants.

Preferably, the temperature of the solid composition and the aqueous solution are in the range from −60° C. to 100° C., alternatively from −40° C. to 50° C. The rate of addition may vary depending on the desired rate of hydrogen generation. Preferably, the mixture formed when the solid composition contacts the aqueous solution is not agitated.

The method of this invention allows generation of hydrogen with the capability of stopping said generation relatively quickly after stopping the addition of the aqueous solution. This capability is important in hydrogen fuel cells, where power generation on demand is a key concern. Inability to stop the flow of hydrogen is detrimental to rapid on/off operation of the fuel cell. Linearity of hydrogen generation over time and/or the amount of aqueous solution added is also an important capability in a hydrogen fuel cell.

### EXAMPLES

### Example 1

### Generation of Hydrogen Gas from SBH and Aqueous Malic Acid or CoCl₂

Mixtures of SBH and NaOH were prepared, as listed in Table 1 below. Approximately 0.5-0.7 grams of each mixture was compacted at 10,000 psi (68.9 kPa) and placed in a reactor that was connected to a reservoir of water. The water in the reservoir was displaced when hydrogen gas was evolved. A solution of 25 wt % malic acid was syringe pumped to the solid at a rate of 100 microliters per minute for ten minutes at which time the pumps were turned off and the amount of water that continued to be displaced was monitored and recorded as a measure of the amount of time (in seconds unless otherwise indicated) elapsed until the hydrogen flow stopped. For times less than 30 minutes, times for two runs are listed.

TABLE 1

| SBH Additive | Aqueous Solution | Time to Stop Flow | |
|---|---|---|---|
| none | 25% malic acid | >30 | min. |
| 2% NaOH | 25% malic acid | >30 | min. |
| 5% NaOH | 25% malic acid | 627, 613 | |
| 10% NaOH | 25% malic acid | 390, 399 | |
| 13% NaOH | 25% malic acid | 108, 80 | |
| 15% NaOH | 25% malic acid | 62, 65 | |
| 20% NaOH | 25% malic acid | 40, 37 | |
| 25% NaOH | 25% malic acid | 30, 25 | |
| 50% NaOH | 25% malic acid | 5, 10 | |
| none | 4.6% CoCl₂ | >30 | min. |
| 13% NaOH | 4.6% CoCl₂ | >30 | min. |
| 20% polyacrylic acid | 25% malic acid | >30 | min. |
| 20% polyacrylic acid | 4.6% CoCl₂ | >30 | min. |
| 20% IRP-64* | 25% malic acid | >30 | min. |
| 20% IRP-64* | 4.6% CoCl₂ | >30 | min. |
| 20% Angelic acid | 25% malic acid | >30 | min. |
| 20% Angelic acid | 4.6% CoCl₂ | >30 | min. |

*IRP-64 is a copolymer of methacrylic acid and divinylbenzene.

### Example 2

### Generation of H₂ vs. Time from SBH and Aqueous Malic Acid

Mixtures of SBH and NaOH were prepared, as listed in Table 2 below. Generation of hydrogen was performed as described in Example 1. Volume of hydrogen gas evolved was noted at regular time intervals (in minutes) and correlated with time to determine linearity. The correlation coefficients, R², obtained from data from 1 minute to 20 minutes, also are listed for each material.

TABLE 2

| | 5% | 15% | 10% | 2% | 13% | 100% |
|---|---|---|---|---|---|---|
| | NaOH | NaOH | NaOH | NaOH | NaOH | SBH |
| 1 min. | 0 | 40 | 39 | 56 | 57 | 0.4 |
| 2 min. | 0 | 78 | 88 | 110 | 120 | 0 |
| 3 min. | 0 | 132 | 144 | 184 | 181 | 0 |
| 4 min. | 47 | 188 | 196 | 246 | 239 | 0 |
| 5 min. | 112 | 243 | 246 | 310 | 298 | 136 |
| 6 min. | 167 | 297 | 292 | 370 | 338 | 102 |
| 7 min. | 217 | 353 | 340 | 435 | 386 | 164 |
| 8 min. | 271 | 398 | 391 | 501 | 440 | 227 |
| 9 min. | 335 | 446 | 458 | 581 | 521 | 282 |
| 10 min. | 371 | 485 | 520 | 649 | 596 | 327 |
| 11 min. | 409 | 527 | 582 | 716 | 671 | 368 |
| 12 min. | 454 | 574 | 636 | 769 | 746 | 422 |
| 13 min. | 508 | 641 | 691 | 802 | 817 | 466 |
| 14 min. | 569 | 710 | 741 | 853 | 875 | 519 |
| 15 min. | 602 | 754 | 780 | 915 | 939 | 579 |
| 16 min. | 638 | 770 | 805 | 970 | 983 | 630 |
| 17 min. | 666 | 796 | 822 | 1031 | 1012 | 673 |
| 18 min. | 700 | 809 | 835 | 1108 | 1051 | 711 |
| 19 min. | 726 | 823 | 845 | 1152 | 1101 | 754 |
| 20 min. | 732 | 834 | 849 | 1182 | 1121 | 807 |
| 21 min. | 736 | 843 | 851 | 1214 | 1137 | 864 |
| 22 min. | 736 | 848 | 853 | 1230 | 1150 | 923 |
| 23 min. | 736 | 853 | 853 | 1239 | 1155 | 979 |
| 24 min. | 736 | 855 | 853 | 1247 | 1157 | 1026 |
| 25 min. | 736 | 856 | 853 | 1254 | 1159 | 1067 |
| 26 min. | 736 | 856 | 853 | 1259 | 1161 | 1095 |
| 27 min. | 736 | 856 | 853 | 1263 | 1161 | 1095 |
| R² | 0.99 | 0.98 | 0.98 | 0.99 | 0.99 | 0.99 |

### Example 3

### Generation of H₂ vs. Time from SBH and 4.6% CoCl₂

Mixtures of SBH and NaOH were prepared, as listed in Table 3 below. Generation of hydrogen was performed as described in Example 1, except that 4.6 wt % CoCl₂ in water was added in place of aqueous malic acid. Volume of hydrogen gas evolved was noted at regular time intervals (in minutes) and correlated with time to determine linearity. The correlation coefficients, R², obtained from data from 1 minute to 20 minutes, also are listed for each material.

The results demonstrate that the method of this invention generates hydrogen with a good linear relationship between volume of aqueous solution added and the volume of hydrogen generated, as shown by the higher correlation coefficients in Table 2, relative to those in Table 3. The method also provides better capability for stopping hydrogen generation when flow of aqueous phase is stopped, as shown in Table 1.

TABLE 3

| | 5% | 15% | 25% | 100% |
|---|---|---|---|---|
| | NaOH | NaOH | NaOH | SBH |
| 1 min. | 0 | 0 | 9 | 3 |
| 2 min. | 0 | 0 | 78 | 37 |
| 3 min. | 10 | 30 | 182 | 71 |
| 4 min. | 42 | 121 | 228 | 115 |
| 5 min. | 167 | 207 | 292 | 174 |
| 6 min. | 387 | 261 | 352 | 250 |
| 7 min. | 487 | 331 | 387 | 430 |
| 8 min. | 583 | 398 | 439 | 611 |
| 9 min. | 664 | 472 | 438 | 695 |
| 10 min. | 730 | 556 | 438 | 733 |
| 11 min. | 800 | 649 | 605 | 799 |
| 12 min. | 865 | 729 | 665 | 885 |
| 13 min. | 895 | 832 | 710 | 950 |
| 14 min. | 918 | 899 | 714 | 974 |
| 15 min. | 952 | 924 | 729 | 989 |
| 16 min. | 984 | 942 | 745 | 996 |
| 17 min. | 992 | 954 | 766 | 999 |
| 18 min. | 999 | 970 | 791 | 1003 |
| 19 min. | 1006 | 985 | 825 | 1006 |
| 20 min. | 1012 | 992 | 855 | 1008 |
| 21 min. | 1016 | 1001 | 875 | |
| 22 min. | 1018 | 1014 | 886 | |
| 23 min. | 1019 | 1030 | 894 | |
| 24 min. | 1022 | 1051 | 901 | |
| 25 min. | 1023 | 1085 | 906 | |
| 26 min. | 1023 | 1111 | 909 | |
| 27 min. | 1023 | 1132 | 911 | |
| 28 min. | 1023 | 1150 | 913 | |
| R² | 0.90 | 0.96 | 0.95 | 0.9 |

1. A method for generation of hydrogen comprising:
(a) providing a solid composition comprising from 3% to 50% of at least one base; and 50% to 97% of at least one borohydride compound; and
(b) adding to the solid composition an aqueous solution of at least one acid; said aqueous solution comprising from 0.01 to 2 equivalents of acid;
wherein the solid composition and the aqueous solution are substantially free of transition metals from groups 8, 9 and 10.

2. The method of claim 1 in which said at least one borohydride compound is at least one alkali metal borohydride, and said at least one base is sodium, lithium or potassium hydroxide, sodium or potassium methoxide, or a combination thereof.

3. The method of claim 2 in which in which the solid composition comprises at least 5% of said at least one base and no more than 95% alkali metal borohydride.

4. The method of claim 3 in which said at least one alkali metal borohydride is sodium borohydride, potassium borohydride or a combination thereof

5. The method of claim 4 in which the acid is a C₂-C₅ dicarboxylic acid, a C₂-C₅ hydroxy carboxylic acid, a C₂-C₅ hydroxy dicarboxylic acid or a combination thereof.

6. The method of claim 5 in which the alkali metal borohydride is sodium borohydride and the base is sodium hydroxide.

7. The method of claim 6 in which the acid is selected from among the group consisting of malic acid, citric acid, tartaric acid, malonic acid, oxalic acid and combinations thereof.

8. The method of claim 7 in which the aqueous solution comprises from 0.1 to 1 equivalents of acid.

9. The method of claim 8 in which the solid composition comprises from 5% to 15% of sodium hydroxide and from 85% to 95% sodium borohydride.
